(19) United States
(12) Patent Application Publication
(10) Pub. No.: US 2026/0316710 A1
(43) Pub. Date: Oct. 15, 2026

(54) ONE-PIECE WOVEN AIR-BAG FABRIC STRUCTURE

(71) Applicant: Autoliv Development AB, Vargarda (SE)

(72) Inventors: Gary WOOTTON, Staffordshire (GB); Jez DOLMAN, Cheshire (GB); Andy HOLLIES, Staffordshire (GB); Helen DEAN, Staffordshire (GB); Ryan THORPE, Derbyshire (GB)

(21) Appl. No.: 19/491,537

(22) PCT Filed: Jul. 1, 2024
(86) PCT No.: PCT/EP2024/068492

§ 371 Date: Dec. 9, 2025

(30) Foreign Application Priority Data
Jul. 4, 2023 (DE) 102023117667.6

(51) Int. Cl. B60R 21/235; B60R 21/261

(52) U.S. Cl. CPC B60R 21/235; B60R 21/261; B60R 2021/23509; B60R 2021/23538; B60R 2021/23571; B60R 2021/2612

(57) ABSTRACT

A one-piece woven air-bag fabric structure (16) comprising a first layer (17) comprising a plurality of first warp yarns (18) and a plurality of first weft yarns (19), wherein at least some of the first weft yarns (19) are woven with the first warp yarns (18). The air-bag fabric structure (16) comprises a second layer (20) at least partly superimposed on the first layer (17), the second layer (20) comprising a plurality of second warp yarns (21) and a plurality of second weft yarns (22), wherein at least some of the second weft yarns (22) are woven with the second warp yarns (21). The air-bag fabric structure (16) further comprises a modified weave portion (15) comprising a respective portion of each of a predetermined number of the second warp yarns (21) woven with at least some of the first weft yarns (19) and not woven with the second weft yarns (22) such that the weaving density of the first layer (17) is greater than the weaving density of the second layer (20) at the modified weave portion (15).

### FIELD

The present invention relates to a one-piece woven air-bag fabric structure and a method of manufacturing a one-piece woven air-bag fabric structure. The present invention more particularly relates to a one-piece woven air-bag fabric structure comprising a modified weave portion configured to receive part of a gas outlet tube of an inflator.

### BACKGROUND

A conventional air-bag is typically constructed from two fabric layers that are cut and sewn together with the seams being sealed so that the air-bag can be inflated by gas from an inflator.

FIG. 1 of the accompanying drawings shows a conventional inflatable curtain air-bag 1 that is of a cut and sew and seam sealed construction. The air-bag 1 comprises a first fabric layer 2 that is sewn to a second fabric layer (not visible in FIG. 1) along a seam 3 which extends around the periphery of the fabric layers.

The air-bag 1 comprises an inflatable portion 4 and an uninflatable portion 5. The uninflatable portion 5 is configured as a single layer of fabric to reduce the weight of this portion of the air-bag 1 in a region where no cushioning is required to protect an occupant of a vehicle.

The air-bag 1 is provided with an aperture 6 which, in this example, is a slit, for receiving a gas outlet tube of an inflator. In a conventional air-bag, such as the air-bag 1 shown in FIG. 1, the aperture 6 is cut in the first layer of fabric 2 before the two layers of fabric are sewn together.

It is relatively easy to cut the aperture 6 in the first layer of fabric 2 before the two layers of fabric are sewn together, for instance using a laser cutter. However, the step of cutting an aperture for an inflator is more difficult to perform when an air-bag is constructed using one-piece weaving (OPW) because the layers are formed integrally with one another. An OPW air-bag is formed permanently as a two-layer fabric structure and laser cutting an aperture in one layer of an OPW fabric structure is not possible without also cutting the other layer of the OPW fabric structure. To overcome this issue, it is known to insert a dolly or shield between the two layers of an OPW fabric structure to block the laser so that the laser does not cut the other layer of the fabric structure. This enables an aperture to be cut in one layer of the fabric structure without cutting the other layer of the fabric structure.

While using a dolly is effective, it is impractical and inefficient since inserting and removing the dolly from the OPW fabric structure adds time and complexity to the manufacturing process.

There is a need for an improved one-piece woven air-bag fabric structure and method of manufacturing the same which addresses the problems described herein.

### BRIEF DESCRIPTION OF THE INVENTION

The present invention provides a one-piece woven air-bag fabric structure as claimed in claims 1 and 6, an air-bag as claimed in claim 11, an air-bag module as claimed in claim 13, a method of manufacturing a one-piece woven air-bag fabric structure as claimed in claims 14 and 17, and a method of manufacturing an air-bag as claimed in claim 20. The present invention also provides preferred embodiments as claimed in the dependent claims.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a diagrammatic view of a conventional cut and sew and seam sealed air-bag;

FIG. 2 is a diagrammatic view of a one-piece woven air-bag of examples of this disclosure;

FIG. 3 is a diagrammatic view of part of an air-bag comprising a one-piece woven air-bag fabric structure of examples of this disclosure;

FIG. 4 is a diagrammatic view of part of an air-bag comprising a one-piece woven air-bag fabric structure of further examples of this disclosure; and

FIG. 5 is a diagrammatic view of an aperture in the part of the air-bag comprising a one-piece woven air-bag fabric structure shown in FIG. 3.

### DETAILED DESCRIPTION OF THE DISCLOSURE

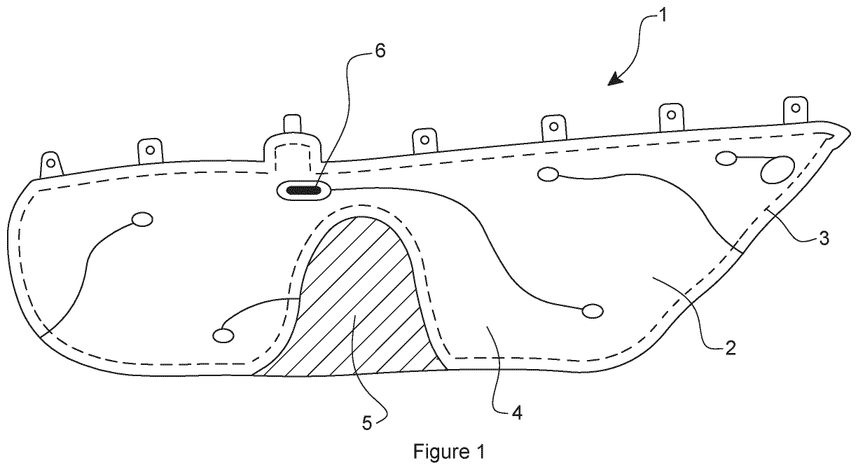

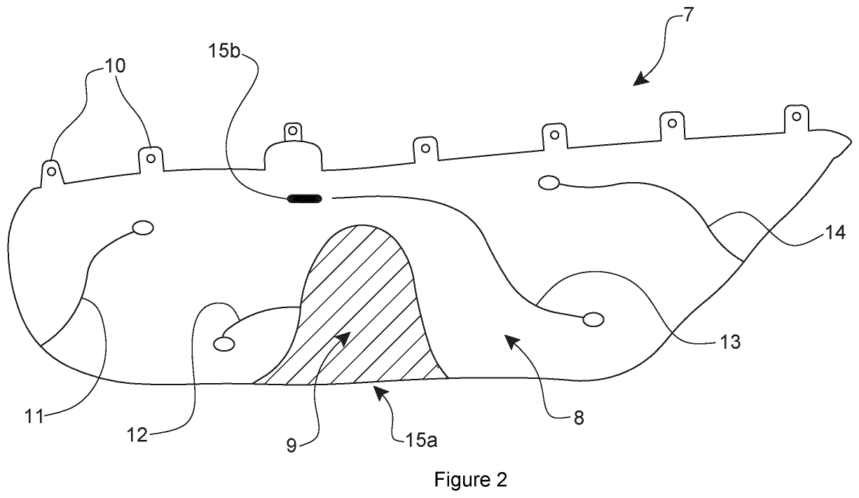

Referring now to FIG. 2 of the accompanying drawings, an air-bag 7 of examples of this disclosure is a one-piece woven (OPW) air-bag. In this example, the air-bag 7 is an inflatable curtain air-bag that is similar in shape to the conventional cut and sew and seam sealed air-bag 1 shown in FIG. 1. However, unlike the conventional air-bag 1, the air-bag 7 of this example is an OPW air-bag and, as such, is manufactured without the fabric layers of the air-bag 7 being cut and sewn together. The OPW air-bag 7 comprises a plurality of layers which are manufactured in one piece using one-piece weaving.

In this example, the air-bag 7 is an inflatable curtain air-bag for a vehicle. However, in other examples, the air-bag may be any other type of air-bag that is formed using one-piece weaving.

In this example, the air-bag 7 comprises an inflatable portion 8 and an uninflatable portion 9.

The air-bag 7 comprises at least one or a plurality of optional mounting elements 10 to mount the air-bag 7 to part of a vehicle.

In this example, the air-bag 7 comprises a plurality of uninflatable line portions 11-14 which extend between the two layers of the inflatable portion 8 of the air-bag 7 to modify the shape of the air-bag 7 once the air-bag 7 is inflated. In this example, the uninflatable line portions 11-14 control the flow of a gas introduced into the air-bag 7 by an inflator (not shown) so that the air-bag 7 inflates across its entire length in a desired manner. However, in other examples, the air-bag 7 comprises a greater or fewer number of uninflatable line portions, or the uninflatable line portions may be omitted.

The air-bag 7 comprises a first modified weave portion 15a which forms at least part of the uninflatable portion 9. In this example, the air-bag 7 comprises a second modified weave portion 15b which provides an open or substantially open portion in one of the layers of fabric of the air-bag 7 which functions either as a vent or as an opening so that part of a gas outlet tube of an inflator can be inserted through the layer of fabric.

In another example, the second modified weave portion 15b is omitted and the vent or opening to receive a gas outlet tube of an inflator is instead formed using a different technique.

In a further example, the first modified weave portion 15a is omitted and the uninflatable portion 9 is instead formed using a different technique.

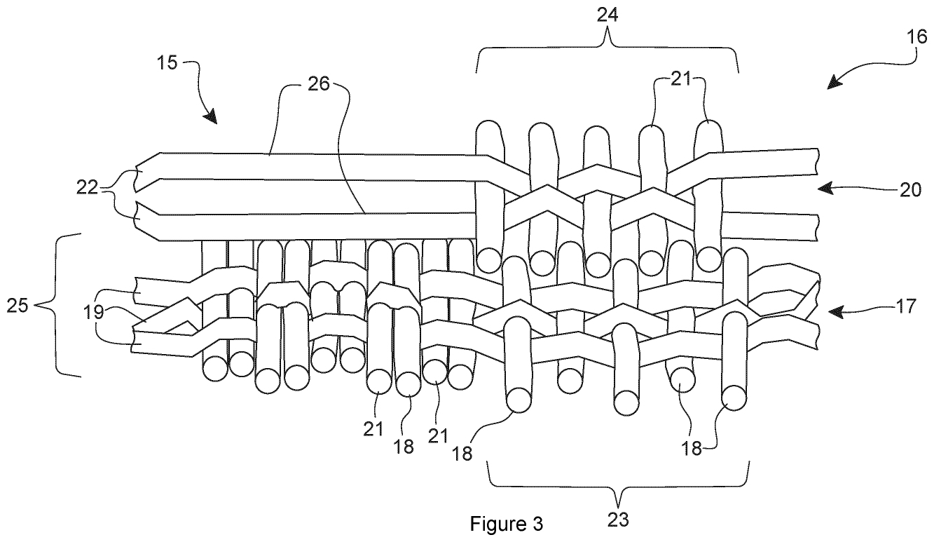

Referring now to FIG. 3 of the accompanying drawings, a one-piece woven air-bag fabric structure 16 forms a respective part of the air-bag 7 which incorporates a modified weave portion 15 forming either the first modified weave portion 15a or the second modified weave portion 15b. The modified weave portion 15 will be described in detail below and it is to be appreciated that the modified weave portion 15 represents the first modified weave portion 15a or the second modified weave portion 15b in examples of this disclosure.

The air-bag fabric structure 16 comprises a first layer 17 comprising a plurality of first warp yarns 18 and a plurality of first weft yarns 19. At least some of the first weft yarns 19 are woven with the first warp yarns 18 to form one layer of fabric of the air-bag 7. In this example, the first warp yarns 18 are arranged side by side and generally parallel with one another and the first weft yarns 19 are interwoven with the first warp yarns 18.

The air-bag fabric structure 16 comprises a second layer 20 which is at least partly superimposed on the first layer 17. The second layer comprises a plurality of second warp yarns 21 and a plurality of second weft yarns 22. At least some of the second weft yarns 22 are woven with the second warp yarns 21 to form another layer of fabric of the air-bag 7. In this example, the second warp yarns 21 are arranged side by side and generally parallel with one another and the second weft yarns 22 are interwoven with the second warp yarns 21.

In this example, a first portion 23 of the first layer 17 forms a portion of a layer of the inflatable portion 8 of the air-bag 7. A second portion 24 of the second layer 20 forms a portion of another layer of the inflatable portion 8 of the air-bag 7. In this example, the first and second portions 23, 24 of the first and second layers 17, 20 have the same or substantially the same weaving density as one another. In this example, the weaving density of the first and second portions 23, 24 is 21.5 warp yarns per centimetre and 19.3 weft yarns per centimetre. In other examples, the weaving density of the first and second portions 23, 24 is 11.5-31.5 warp yarns per centimetre and 9.3-29.3 weft yarns per centimetre.

The modified weave portion 15 of the air-bag fabric structure 16 comprises a respective portion 25 of each of a predetermined number of the second warp yarns 21 woven with at least some of the first weft yarns 19 and not woven with the second weft yarns 22. Weaving second warp yarns 21 with the first weft yarns 19 instead of the second weft yarns 22 in this way results in the weaving density of the first layer 17 being greater than the weaving density of the second layer 20 at the modified weave portion 15.

In this example, at the modified weave portion 15 the weaving density of the first layer 17 is 19.3 weft yarns per centimetre and 43 (21.5+21.5) warp yarns per centimetre and the weaving density of the second layer 20 is 19.3 weft yarns per centimetre and zero warp yarns per centimetre.

In other examples, a predetermined number of the second warp yarns 21 are woven with the second weft yarns 22 at the modified weave portion 15 to support the second weft yarns 22 and retain the second weft yarns 22 in a position substantially adjacent to the first layer 17. The second weft yarns 22 are thus retained in position so that the second weft yarns 22 do not hang loosely at the modified weave portion 15.

In this example, at least some of the second weft yarns 22 each comprise a respective float section 26 (only two of which are shown in FIG. 3) that is not woven with the first warp yarns 18 or the second warp yarns 21 at the modified weave portion 15.

In the examples described above, at the modified weave portion 15 all or a predetermined number of the second warp yarns 21 are woven (or “hidden”) with at least some of the first weft yarns 19 and not woven with the second weft yarns 22. In other examples, instead of the second warp yarns 21, all or a predetermined number of the second weft yarns 22 are woven (or “hidden”) with at least some of the first warp yarns 18 and not woven with the second warp yarns 21 at the modified weave portion 15. However, the end result is the same or substantially the same since the weaving density of the first layer 17 is still greater than the weaving density of the second layer 20 at the modified weave portion 15. It is to be appreciated that either the second warp yarns 21 may be woven with the first weft yarns 19 or the second weft yarns 22 may be woven with the first warp yarns 18 in examples of this disclosure.

A method of manufacturing the one-piece woven air-bag fabric structure 16 comprises one-piece weaving the first layer 17, the second layer 20 and the modified weave portion 15. The method comprises weaving the first layer 17 by weaving the plurality of first warp yarns 18 with at least some of a plurality of first weft yarns 19 and weaving a second layer 20 which is at least partly superimposed on the first layer 17 by weaving a plurality of second warp yarns 21 with at least some of a plurality of second weft yarns 22.

The method further comprises weaving a modified weave portion 15 by weaving a respective portion of each of the predetermined number of the second warp yarns 21 with at least some of the first weft yarns 19 and not weaving the respective portion of each of a predetermined number of the second warp yarns 21 with the second weft yarns 22. This ensures that the weaving density of the first layer 17 is greater than the weaving density of the second layer 20 at the modified weave portion 15.

In a method of further examples of this disclosure, instead of a predetermined number of the second warp yarns 21, a predetermined number of the second weft yarns 22 are woven (or “hidden”) with at least some of the first warp yarns 18 and not woven with the second warp yarns 21.

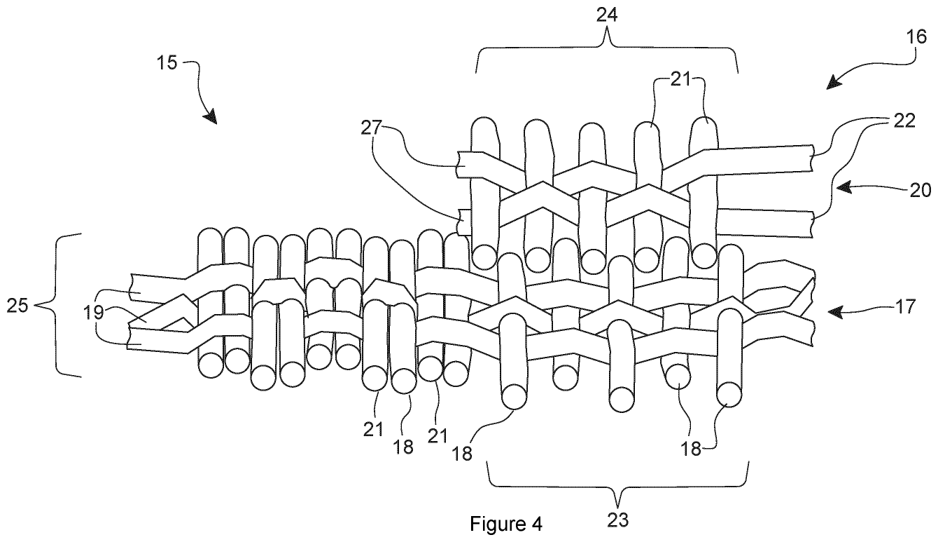

Referring now to FIG. 4 of the accompanying drawings, in some examples at least some of the second weft yarns 22 are cut and do not extend from a first side of the modified weave portion 15 to a second side of the modified weave portion 15. Free ends 27 of the second weft yarns 22 remain at the first side of the modified weave portion 15. There are also free ends (not shown) of the second weft yarns 22 at the second side of the modified weave portion 15.

In this example, the float portions 26 are cut by laser cutting or another cutting method and removed to form the modified weave portion 15.

The configuration of the modified weave portion 15 enables a laser cutter to cut the float sections 26 of the second weft yarns 22 with a lower laser power since the weaving density of the second layer 20 is lower than the surrounding fabric of the air-bag 7 at the modified weave portion 15.

The laser cutting can be done without needing to use a dolly because the weaving density of the first layer 17 at the modified weave portion 15 is relatively high and is thus less susceptible to being cut by the laser than the lower density float sections 26 of the second weft yarns 22. Consequently, a one-piece woven air-bag fabric structure or one-piece woven air-bag comprising the fabric structure can be manufactured using one-piece weaving and the aperture 33 can be cut in the second layer 20 quickly and easily using a laser cutter without the extra steps of inserting and removing a dolly. The complexity and cost of manufacturing the air-bag is therefore reduced compared with conventional air-bags that require the use of a dolly during laser cutting.

In the case of the first modified weave portion 15a, the portion of the first layer 17 having a greater weaving density than the second layer 20 at the first modified weave portion 15a forms at least part of the uninflatable portion 9 of the air-bag 7. In the case of the second modified weave portion 15b, an aperture is formed in the second layer 20 due to the cutaway float portions 26.

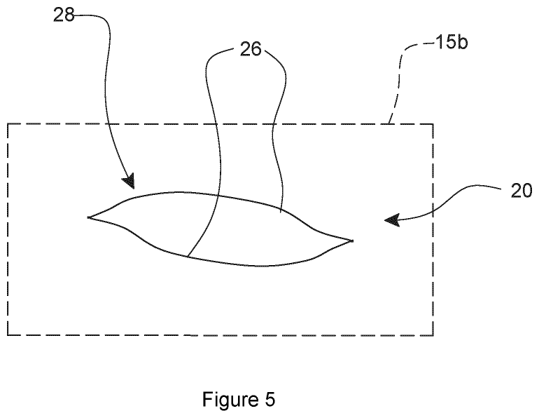

Referring now to FIG. 5 of the accompanying drawings, in another example the float sections 26 are not cut and instead remain in place to form the second modified weave portion 15b. In this example, the less dense weave of the second layer 20 relative to the first layer 17 at the modified weave portion 15b enables part of a gas outlet tube of an inflator (not shown) to be inserted between at least two of the float sections 26 of the second weft yarns 22 and through the second layer 20.

In this example an aperture 28 in the form of an open or substantially open slit is formed between the float sections 26 of the second weft yarns 22 as the air-bag fabric structure 16 is manufactured using one-piece weaving. This enables the inflator to be fluidly coupled to the interior of the air-bag 7 through the aperture 28, which is pre-formed without needing to cut or remove any material from the second layer 20 of the air-bag fabric structure 16. The time and complexity of the process of manufacturing the air-bag 7 is reduced since the process does not require any cutting step to form an aperture for the inflator.

In further examples of this disclosure, a method comprises one-piece weaving an air-bag or a part of an air-bag with the method comprising one-piece weaving an air-bag fabric structure 16 as described above. In yet further examples, the method comprises manufacturing an air-bag as described above and attaching an inflator to the air-bag, with a gas outlet tube of the inflator extending into the opening or substantial opening formed by the lower density weave layer at the modified weave portion 15.

In further examples, an air-bag module comprises an inflator provided with a gas outlet tube, with part of the gas outlet tube extending through the second layer 20 at the modified weave portion 15. Upon activation of the inflator, gas is output from the inflator and passes through the gas outlet tube and into the air-bag to inflate the air-bag.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

### REPRESENTATIVE FEATURES

Representative features are set out in the following clauses, which stand alone or may be combined, in any combination, with one or more features disclosed in the text and/or drawings of the specification.
1. A one-piece woven air-bag fabric structure comprising:
   a first layer comprising:
      a plurality of first warp yarns; and
      a plurality of first weft yarns, wherein at least some of the first weft yarns are woven with the first warp yarns;
   a second layer at least partly superimposed on the first layer, the second layer comprising:
      a plurality of second warp yarns; and
      a plurality of second weft yarns, wherein at least some of the second weft yarns are woven with the second warp yarns; and
   a modified weave portion comprising:
      a respective portion of each of a predetermined number of the second warp yarns woven with at least some of the first weft yarns and not woven with the second weft yarns such that the weaving density of the first layer is greater than the weaving density of the second layer at the modified weave portion.
2. The fabric structure of clause 1, wherein at least some of the second weft yarns are cut and do not extend from a first side of the modified weave portion to a second side of the modified weave portion.
3. The fabric structure of clause 2, wherein at least part of the modified weave portion is an uninflatable portion of the air-bag fabric structure.
4. The fabric structure of clause 2, wherein a portion of the second layer at the modified weave portion of the fabric structure comprises an aperture in the second layer between the first side of the modified weave portion and the second side of the modified weave portion.
5. The fabric structure of clause 1, wherein at least some of the second weft yarns each comprise a respective float section that is not woven with the first warp yarns or the second warp yarns at the modified weave portion.
6. A one-piece woven air-bag fabric structure comprising:
   a first layer comprising:
      a plurality of first warp yarns; and
      a plurality of first weft yarns, wherein at least some of the first weft yarns are woven with the first warp yarns;
   a second layer at least partly superimposed on the first layer, the second layer comprising:
      a plurality of second warp yarns; and
      a plurality of second weft yarns, wherein at least some of the second weft yarns are woven with the second warp yarns; and
   a modified weave portion comprising:
      a respective portion of each of a predetermined number of the second weft yarns woven with at least some of the first warp yarns and not woven with the second warp yarns such that the weaving density of the first layer is greater than the weaving density of the second layer at the modified weave portion.
7. The fabric structure of clause 6, wherein at least some of the second warp yarns are cut and do not extend from one side of the modified weave portion to another side of the modified weave portion.
8. The fabric structure of clause 7, wherein at least part of the modified weave portion is an uninflatable portion of the air-bag fabric structure.
9. The fabric structure of clause 7, wherein a portion of the second layer at the modified weave portion of the fabric structure comprises an aperture in the second layer between the first side of the modified weave portion and the second side of the modified weave portion.
10. The fabric structure of clause 6, wherein at least some of the second warp yarns each comprise a respective float section that is not woven with the first weft yarns or the second weft yarns at the modified weave portion.
11. A one-piece woven air-bag comprising the fabric structure of any one of the preceding clauses.
12. The air-bag of clause 11, wherein the first layer of the fabric structure at the modified weave portion is an uninflatable portion of the air-bag.
13. An air-bag module comprising:
   an inflator provided with a gas outlet tube; and
   the air-bag of clause 11 or clause 12, wherein part of the gas outlet tube extends through the second layer of the fabric at the modified weave portion so that, upon activation of the inflator, gas output from the inflator passes through the gas outlet tube and into the air-bag to inflate the air-bag.
14. A method of manufacturing a one-piece woven air-bag fabric structure, the method comprising one-piece weaving:
   a first layer by weaving a plurality of first warp yarns with at least some of a plurality of first weft yarns;
   a second layer which is at least partly superimposed on the first layer by weaving a plurality of second warp yarns with at least some of a plurality of second weft yarns; and
   a modified weave portion by weaving a respective portion of each of a predetermined number of the second warp yarns with at least some of the first weft yarns and not weaving the respective portion of each of a predetermined number of the second warp yarns with the second weft yarns such that the weaving density of the first layer is greater than the weaving density of the second layer at the modified weave portion.
15. The method of clause 14, wherein the method comprises:
   cutting and removing each float section from the fabric so that at least some of the second weft yarns do not extend from a first side of the modified weave portion to a second side of the modified weave portion.
16. The method of clause 14, wherein the method comprises:
   providing at least some of the second weft yarns with a respective float section by not weaving at least some of the second weft yarns with the first warp yarns or the second warp yarns at the modified weave portion.
17. A method of manufacturing a one-piece woven air-bag fabric structure, the method comprising one-piece weaving:
   a first layer by weaving a plurality of first warp yarns with at least some of a plurality of first weft yarns;
   a second layer which is at least partly superimposed on the first layer by weaving a plurality of second warp yarns with at least some of a plurality of second weft yarns; and
   a modified weave portion by weaving a respective portion of each of a predetermined number of the second weft yarns with at least some of the first warp yarns and not weaving the respective portion of each of a predetermined number of the second weft yarns with the second warp yarns such that the weaving density of the first layer is greater than the weaving density of the second layer at the modified weave portion.
18. The method of clause 17, wherein the method comprises:
   cutting and removing each float section from the fabric so that at least some of the second warp yarns do not extend from a first side of the modified weave portion to a second side of the modified weave portion.
19. The method of clause 17, wherein the method comprises:
   providing at least some of the second warp yarns with a respective float section by not weaving at least some of the second warp yarns with the first weft yarns or the second weft yarns at the modified weave portion.
20. A method of manufacturing an air-bag, the method comprising:
   one-piece weaving a fabric structure according to the method of any one of clauses 14 to 19 such that the fabric structure forms part of the air-bag.
21. The method of clause 20 as dependent on clause 16 or clause 19, wherein the Method comprises:
   inserting part of a gas outlet tube of an inflator between at least two of the float sections and through a portion of the second layer at the modified weave portion of the fabric structure.

1-21. (canceled)

22. A one-piece woven air-bag fabric structure comprising:
a first layer comprising:
a plurality of first warp yarns; and
a plurality of first weft yarns, wherein at least some of the first weft yarns are woven with the first warp yarns;
a second layer at least partly superimposed on the first layer, the second layer comprising:
a plurality of second warp yarns; and
a plurality of second weft yarns, wherein at least some of the second weft yarns are woven with the second warp yarns; and
a modified weave portion comprising:
a respective portion of each of a predetermined number of the second warp yarns woven with at least some of the first weft yarns and not woven with the second weft yarns such that the weaving density of the first layer is greater than the weaving density of the second layer at the modified weave portion.

23. The fabric structure of claim 22, wherein at least some of the second weft yarns are cut and do not extend from a first side of the modified weave portion to a second side of the modified weave portion.

24. The fabric structure of claim 23, wherein at least part of the modified weave portion is an uninflatable portion of the air-bag fabric structure.

25. The fabric structure of claim 23, wherein a portion of the second layer at the modified weave portion of the fabric structure comprises an aperture in the second layer between the first side of the modified weave portion and the second side of the modified weave portion.

26. The fabric structure of claim 22, wherein at least some of the second weft yarns each comprise a respective float section that is not woven with the first warp yarns or the second warp yarns at the modified weave portion.

27. A one-piece woven air-bag fabric structure comprising:
a first layer comprising:
a plurality of first warp yarns; and
a plurality of first weft yarns, wherein at least some of the first weft yarns are woven with the first warp yarns;
a second layer at least partly superimposed on the first layer, the second layer comprising:
a plurality of second warp yarns; and
a plurality of second weft yarns, wherein at least some of the second weft yarns are woven with the second warp yarns; and
a modified weave portion comprising:
a respective portion of each of a predetermined number of the second weft yarns woven with at least some of the first warp yarns and not woven with the second warp yarns such that the weaving density of the first layer is greater than the weaving density of the second layer at the modified weave portion.

28. The fabric structure of claim 27, wherein at least some of the second warp yarns are cut and do not extend from one side of the modified weave portion to another side of the modified weave portion.

29. The fabric structure of claim 28, wherein at least part of the modified weave portion is an uninflatable portion of the air-bag fabric structure.

30. The fabric structure of claim 28, wherein a portion of the second layer at the modified weave portion of the fabric structure comprises an aperture in the second layer between the first side of the modified weave portion and the second side of the modified weave portion.

31. The fabric structure of claim 27, wherein at least some of the second warp yarns each comprise a respective float section that is not woven with the first weft yarns or the second weft yarns at the modified weave portion.

32. A one-piece woven air-bag comprising the fabric structure of claim 22.

33. A one-piece woven air-bag comprising the fabric structure of claim 27.

34. The air-bag of claim 32, wherein the first layer of the fabric structure at the modified weave portion is an uninflatable portion of the air-bag.

35. The air-bag of claim 33, wherein the first layer of the fabric structure at the modified weave portion is an uninflatable portion of the air-bag.

36. An air-bag module comprising:
an inflator provided with a gas outlet tube; and
the air-bag of claim 32, wherein part of the gas outlet tube extends through the second layer of the fabric at the modified weave portion so that, upon activation of the inflator, gas output from the inflator passes through the gas outlet tube and into the air-bag to inflate the air-bag.

37. An air-bag module comprising:
an inflator provided with a gas outlet tube; and
the air-bag of claim 33, wherein part of the gas outlet tube extends through the second layer of the fabric at the modified weave portion so that, upon activation of the inflator, gas output from the inflator passes through the gas outlet tube and into the air-bag to inflate the air-bag.

38. A method of manufacturing a one-piece woven air-bag fabric structure, the method comprising one-piece weaving:
a first layer by weaving a plurality of first warp yarns with at least some of a plurality of first weft yarns;
a second layer which is at least partly superimposed on the first layer by weaving a plurality of second warp yarns with at least some of a plurality of second weft yarns; and
a modified weave portion by weaving a respective portion of each of a predetermined number of the second warp yarns with at least some of the first weft yarns and not weaving the respective portion of each of a predetermined number of the second warp yarns with the second weft yarns such that the weaving density of the first layer is greater than the weaving density of the second layer at the modified weave portion.

39. The method of claim 38, wherein the method comprises:
cutting and removing each float section from the fabric so that at least some of the second weft yarns do not extend from a first side of the modified weave portion to a second side of the modified weave portion.

40. The method of claim 38, wherein the method comprises:
providing at least some of the second weft yarns with a respective float section by not weaving at least some of the second weft yarns with the first warp yarns or the second warp yarns at the modified weave portion.

41. A method of manufacturing an air-bag, the method comprising:
one-piece weaving a fabric structure according to the method of claim 38 such that the fabric structure forms part of the air-bag.
